(19) United States
(12) Patent Application Publication
(10) Pub. No.: US 2006/0201750 A1
(43) Pub. Date: Sep. 14, 2006

(54) Elevator apparatus drive unit, elevator apparatus, elevator apparatus installation method, and elevator apparatus maintenance inspection method

(76) Inventor: Naoki Hashiguchi, (US)

Correspondence Address: BUCHANAN, INGERSOLL & ROONEY PC, POST OFFICE BOX 1404, ALEXANDRIA, VA, 22313-1404, US

(21) Appl. No.: 10/543,377

(22) PCT Filed: Jan. 27, 2004
(86) PCT No.: PCT/JP04/00694

§ 371 Date: Jul. 26, 2005

(51) Int. Cl. B66B 11/08

(52) U.S. Cl. 187/266

(57) ABSTRACT

In an elevator apparatus, a cover body is disposed on an opening portion of a top portion of a hoistway. A driving machine for raising and lowering a car and a counterweight is supported by the cover body. The driving machine has: a driving machine main body; and a drive sheave rotated by the driving machine main body. A main rope is wound around the drive sheave. The car and the counterweight are suspended inside the hoistway by the main rope.

### TECHNICAL FIELD

The present invention relates to an elevator apparatus in which at least a portion of hoistway equipment such as a driving machine, for example, is disposed in an upper portion of a hoistway.

### BACKGROUND ART

In conventional elevator apparatuses such as that shown in Japanese Patent Laid-Open No. 2000-255933 (Gazette), for example, a hoisting machine for raising and lowering a car is installed on a ceiling of a hoistway. After receiving notification from a building contractor to the effect that the hoistway has been built inside a building, the hoisting machine is carried into the hoistway by an elevator contractor, and fixed to the ceiling of the hoistway. Consequently, construction time for elevator apparatus installation work is protracted.

### DISCLOSURE OF THE INVENTION

The present invention aims to solve the above problems and an object of the present invention is to provide an elevator apparatus, an elevator apparatus drive unit, an elevator apparatus installation method, and an elevator apparatus maintenance inspection method enabling installation work time to be shortened.

Another object of the present invention is to utilize internal hoistway space effectively when an elevator apparatus unit is disposed in a top portion of a hoistway.

In order to achieve the above object, according to one aspect of the present invention, there is provided an elevator apparatus drive unit including: a cover body disposed on an opening portion of a top portion of a hoistway; and a driving machine having a drive sheave around which is wound a main rope for suspending a car and a counterweight, and a driving machine main body for rotating the drive sheave, the driving machine being supported by the cover body.

According to another aspect of the present invention, there is provided an elevator apparatus including: a cover body disposed on an opening portion of a top portion of a hoistway; a driving machine having a driving machine main body, and a drive sheave rotated by the driving machine main body, the driving machine being supported by the cover body; a main rope wound around the drive sheave; and a car and a counterweight suspended inside the hoistway by the main rope and raised and lowered by a driving force from the driving machine.

According to yet another aspect of the present invention, there is provided an elevator apparatus including: a hoisted body raised and lowered inside a hoistway that includes an opening portion disposed on a roof portion of a building main body; a supporting frame disposed in an upper portion of the hoistway; and hoistway equipment disposed on the supporting frame.

According to another aspect of the present invention, there is provided an elevator apparatus installation method including: a carrying-in and installing process in which a supporting frame is carried inside a hoistway through an opening portion disposed at a top portion of the hoistway from above the opening portion and installed in an upper portion inside the hoistway; and an equipment mounting process in which hoistway equipment is mounted to the supporting frame.

According to yet another aspect of the present invention, there is provided an elevator apparatus maintenance inspection method including a process in which maintenance inspection work on hoistway equipment is performed inside a hoistway from below a supporting frame.

According to another aspect of the present invention, there is provided an elevator apparatus maintenance inspection method including: a process in which hoistway equipment is removed from a supporting frame inside a hoistway; and a process in which maintenance inspection work is performed on the hoistway equipment.

According to yet another aspect of the present invention, there is provided an elevator apparatus maintenance inspection method including a process in which maintenance inspection work on hoistway equipment is performed from above a roof portion through an opening portion.

### BRIEF DESCRIPTION OF THE DRAWINGS

FIG. 1 is a plan showing internal portions of a hoistway of an elevator apparatus according to Embodiment 1 of the present invention;

FIG. 2 is a side elevation showing the elevator apparatus in FIG. 1;

FIG. 3 is a plan showing a state partway through installation of the elevator apparatus in FIG. 1;

FIG. 4 is a side elevation showing an elevator apparatus according to Embodiment 2 of the present invention;

FIG. 5 is a side elevation showing an elevator apparatus according to Embodiment 3 of the present invention;

FIG. 6 is a side elevation showing an elevator apparatus according to Embodiment 4 of the present invention;

FIG. 7 is a side elevation showing an elevator apparatus according to Embodiment 5 of the present invention;

FIG. 8 is a side elevation showing part of an elevator apparatus according to Embodiment 6 of the present invention;

FIG. 9 is a side elevation showing part of an elevator apparatus according to Embodiment 7 of the present invention;

FIG. 10 is a side elevation showing part of an elevator apparatus according to Embodiment 8 of the present invention;

FIG. 11 is an enlargement showing part of FIG. 10;

FIG. 12 is a side elevation showing part of an elevator apparatus according to Embodiment 9 of the present invention;

FIG. 13 is a side elevation showing part of an elevator apparatus according to Embodiment 10 of the present invention;

FIG. 14 is a side elevation showing part of an elevator apparatus according to Embodiment 11 of the present invention;

FIG. 15 is a plan showing internal portions of a hoistway of an elevator apparatus according to Embodiment 12 of the present invention;

FIG. 16 is a side elevation showing the elevator apparatus in FIG. 15; and

FIG. 17 is a plan showing a state partway through installation of the elevator apparatus in FIG. 15.

### BEST MODE FOR CARRYING OUT THE INVENTION

Preferred embodiments of the present invention will now be explained with reference to the drawings.

### Embodiment 1

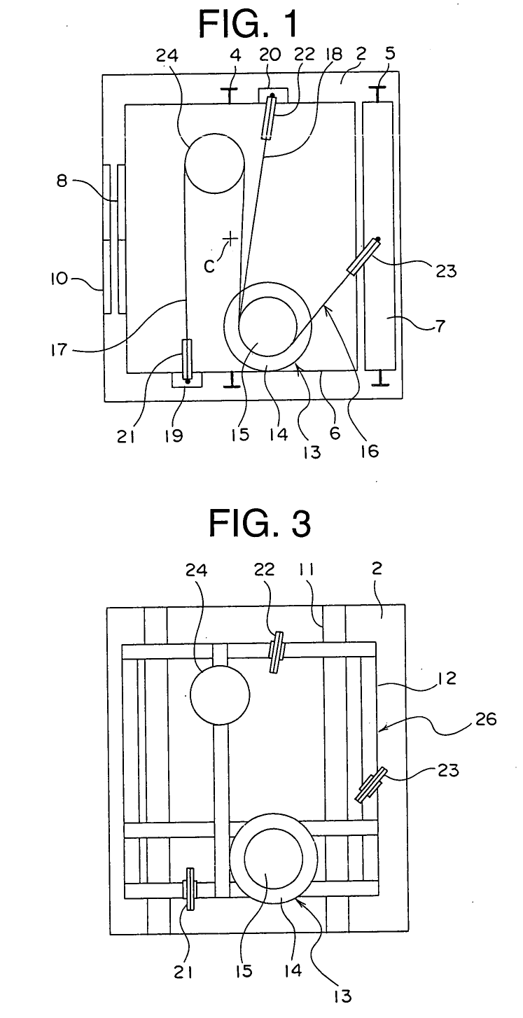

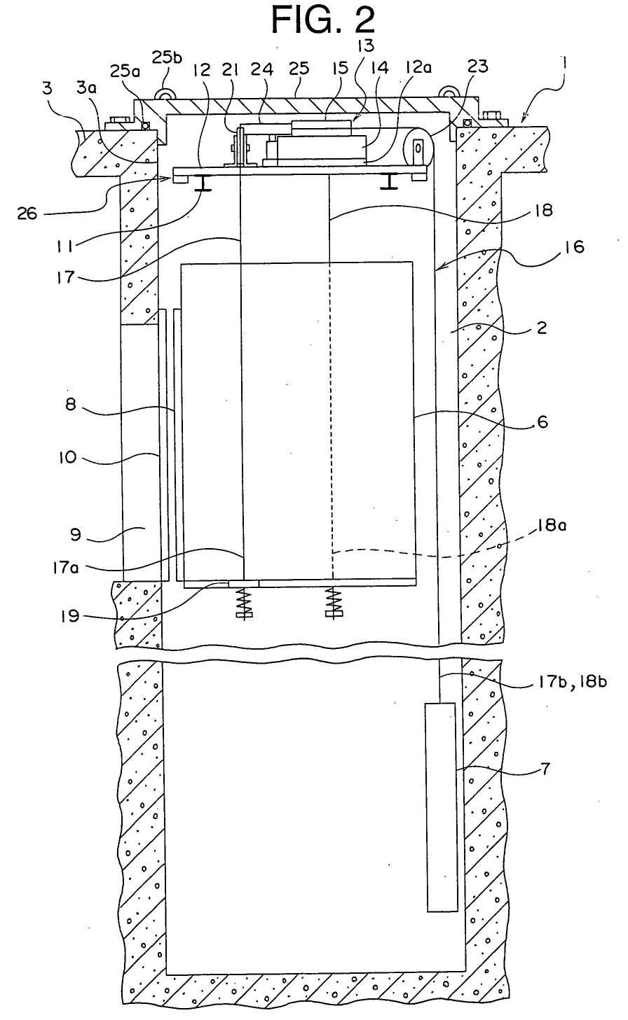

FIG. 1 is a plan showing internal portions of a hoistway of an elevator apparatus according to Embodiment 1 of the present invention, and FIG. 2 is a side elevation showing the elevator apparatus in FIG. 1.

In the figures, a hoistway 2 is disposed in a building main body 1. The hoistway 2 includes an opening portion 3a disposed on a roof portion 3 of the building main body 1. Specifically, the opening portion 3a is positioned at a top portion of the hoistway 2 as a portion of the hoistway 2. In this example, a width dimension and a depth dimension of the opening portion 3a are equal to a width dimension and a depth dimension of the hoistway 2. In other words, an aperture surface area of the opening portion 3a is equal to a horizontal cross-sectional area of the hoistway 2.

A pair of car guide rails 4 and a pair of counterweight guide rails 5 are installed inside the hoistway 2. A car 6 constituting a hoisted body is guided by the car guide rails 4 so as to be raised and lowered inside the hoistway 2. A counterweight 7 constituting a hoisted body is guided by the counterweight guide rails 5 so as to be raised and lowered inside the hoistway 2.

A pair of car doors 8 for opening and closing a car entrance are disposed on a front surface of the car 6. A pair of landing doors 10 operating together with the car doors 8 to open and close a landing entrance 9 are disposed on the landing entrance 9. The car 6 is disposed inside the opening portion 3a when viewed from above.

A pair of structural beams 11 are fixed to an upper portion of the building main body 1. The structural beams 11 are positioned in an upper portion inside the hoistway 2. A supporting frame 12 (not shown in FIG. 1) is fixed onto the structural beams 11. A plurality of beam fixing portions for fixing the supporting frame 12 to the structural beams 11 are disposed on the supporting frame 12. Frame fixing portions for fixing the supporting frame 12 are also disposed on the structural beams 11.

A driving machine 13 functioning as hoistway equipment for raising and lowering the car 6 and the counterweight 7 is mounted onto the supporting frame 12. A driving machine mounting portion (mounting seat) 12a for mounting the driving machine 13 is disposed on the supporting frame 12.

Eighty percent or more of the driving machine 13 (100 percent in FIG. 1) overlaps with the car 6 when viewed from above. In other words, the driving machine 13 is disposed directly above the car 6. The driving machine 13 also has: a driving machine main body 14 including a motor and a brake; and a drive sheave 15 rotated by the driving machine main body 14. In this example, the drive sheave 15 is disposed above the driving machine main body 14.

In addition, the driving machine 13 is disposed horizontally (including generally horizontally) such that a rotating shaft of the drive sheave 15 is vertical (including generally vertical). Furthermore, a thin hoisting machine having an axial dimension that is less than a radial dimension of the drive sheave 15 or a radial dimension of the driving machine main body 14 is used for the driving machine 13. In this example in particular, a ratio between an axial dimension of the driving machine 13 and an external dimension in a direction perpendicular to the axial direction is between 1:2 and 1:6. The drive sheave 15 is driven directly by the motor of the driving machine main body 14 without a speed reducing mechanism.

A main rope group 16 for suspending the car 6 and the counterweight 7 inside the hoistway 2 is wound around the drive sheave 15. The main rope group 16 includes: a plurality of first main ropes 17 (only one is shown in the figures); and a plurality of second main ropes 18 (only one is shown in the figures).

The car 5 and the counterweight 7 are suspended by the main rope group 16 using a one-to-one (1:1) roping method.

A first rope connecting portion 19 to which the first main ropes 17 are connected is disposed on a lower portion of a first side portion in a width direction of the car 6. A second rope connecting portion 20 to which the second main ropes 18 are connected is disposed on a lower portion of a second side portion in a width direction of the car 6. The first and second rope connecting portions 19 and 20 are disposed symmetrically on opposite sides of a center of gravity C of the car 6 from each other or a vicinity thereof when viewed from above. In other words, the car 6 is suspended substantially at its center of gravity or a vicinity thereof.

The first main ropes 17 have: first end portions 17a connected to the first rope connecting portion 19; and second end portions 17b connected to an upper portion of the counterweight 7. The second main ropes 18 have: third end portions 18a connected to the second rope connecting portion 20; and fourth end portions 18b connected to an upper portion of the counterweight 7.

A first pulley 21 for directing the first main ropes 17 to the first rope connecting portion 19, a second pulley 22 for directing the second main ropes 18 to the second rope connecting portion 20, a third pulley 23 for directing the first and second main ropes 17 and 18 to the counterweight 7, and a deflection pulley 24 for directing the first main ropes 17 extending from the drive sheave 15 to the first pulley 21 are mounted onto the supporting frame 12. The first through third pulleys 21 through 23 and the deflection pulley 24 constitute hoistway equipment. The first pulley 21 is disposed nearer to the landing door 10 than the car guide rails 4. The second pulley 22 is disposed nearer to the counterweight 7 than the car guide rails 4.

The first through third pulleys 21 through 23 are disposed such that rotating shafts thereof are horizontal. The deflection pulley 24 is disposed such that a rotating shaft thereof is vertical (including generally vertical).

The driving machine 13 and the pulleys 21 through 24 are unitized by being mounted to the shared supporting frame 12. Specifically, a drive unit 26 according to Embodiment 1 includes the supporting frame 12, the driving machine 13, and the pulleys 21 through 24. Furthermore, in this example, the drive unit 26 is generally disposed entirely inside the opening portion 3a.

A cover 25 for closing the opening portion 3a is fixed onto the roof portion 3. A seal portion 25a for preventing penetration of water into the opening portion 3a, and a plurality of suspending hooks (gripping portions) 25b to which a lifting apparatus (such as a crane apparatus, for example) for lifting the cover 25 can be coupled are disposed on the cover 25. Similar suspending hooks or suspending wire connecting portions are also disposed on the supporting frame 12. The cover 25 can also be constituted by a transparent material.

Next, an installation method will be explained. FIG. 3 is a plan showing a state partway through installation of the elevator apparatus in FIG. 1. In the figure, the drive unit 26 is passed through the opening portion 3a, carried into the hoistway 2 from above the opening portion 3a, and fixed onto the structural beams 11. In other words, mounting of the driving machine 13 and the pulleys 21 through 24 to the supporting frame 12 is executed in advance before processes of carrying in and installing the supporting frame 12.

After the drive unit 26 is carried in and installed in this manner, the cover 25 is fixed onto the roof portion 3. After that, the guide rails 4 and 5 are installed inside the hoistway 2, and the car 6 and the counterweight 7 are carried into the hoistway 2 and assembled. Then, the main rope group 16 is wound around the drive sheave 15 and the pulleys 21 through 24, and the car 6 and the counterweight 7 are suspended by the main rope group 16.

Moreover, the mounting of the driving machine 13 and the pulleys 21 through 24 to the supporting frame 12 may also be executed inside the hoistway 2 after the processes of carrying in and installing the supporting frame 12.

In an elevator apparatus of this kind, because the supporting frame 12 can be carried into the hoistway 2 through the opening portion 3a at the top portion of the hoistway 2, the supporting frame 12 can be carried in in advance during construction of the building main body 1, enabling installation work time to be shortened. In particular, work time can be further shortened by mounting the driving machine 13 and the pulleys 21 through 24 to the supporting frame 12 in advance as a drive unit 26.

By leaving the supporting frame 12 (or the drive unit 26) and the cover 25 with a building contractor, and having the building contractor perform installation (or temporary placement) of the supporting frame 12 and the cover 25 at a stage when the hoistway 2 is completed, for example, an elevator installation contractor can execute remaining installation work in any subsequent period, significantly improving efficiency of the installation work.

Here, position adjustment between the guide rails 4 and 5 installed inside the hoistway 2 and the driving machine 13 and the pulleys 21 through 24 mounted to the supporting frame 12 can be performed by disposing equipment position adjusting mechanisms on the supporting frame 12 for adjusting the mounted positions of the hoistway equipment relative to a supporting frame main body. In other words, the mounted positions of the driving machine 13 and the pulleys 21 through 24 on the supporting frame 12 may be adjusted using the equipment position adjusting mechanisms after installation of the guide rails 4 and 5.

Frame position adjusting mechanisms for adjusting the mounted position of the supporting frame 12 relative to the building main body 1 may be also disposed. Thus, the mounted position of the entire drive unit 26 can be adjusted relative to the guide rails 4 and 5 with relative positional relationships among the driving machine 13 and the pulleys 21 through 24 maintained without modification.

In addition, prepositioned reference surfaces may also be disposed on the building main body 1 in advance based on installation positions of the guide rails 4 and 5, and positioning surfaces that can be placed in contact with those reference surfaces may be predisposed on the supporting frame 12. Using this method, positioning between the hoistway equipment mounted to the supporting frame 12 and the guide rails 4 and 5 can be performed simply by placing the positioning surfaces in contact with the reference surfaces during installation of the supporting frame 12.

Rail positioning portions for performing relative positioning between the hoistway equipment mounted to the supporting frame 12 and the guide rails 4 and 5 may also be predisposed on the supporting frame 12.

Thus, examples of methods for relative positioning between the guide rails 4 and 5 and the hoistway equipment include methods in which the guide rails 4 and 5 are installed based on the position of the hoistway equipment, and methods in which the position of the hoistway equipment is adjusted based on the position of the guide rails 4 and 5. When positioning of the supporting frame 12 is not performed, the former methods are effective, and when positioning of the supporting frame 12 is performed in advance, the latter methods can be adopted, enabling the efficiency of installation work to be improved.

Next, maintenance inspection methods for hoistway equipment such as the driving machine 13 and the pulleys 21 through 24, etc., will be explained. A first method for maintenance inspection work is a method performed inside the hoistway 2 from below the supporting frame 12. In this case, a worker, for example, may perform maintenance inspection work by climbing onto the car 6. If maintenance inspection work on the driving machine 13 is to be performed from below, it is preferable for the driving machine 13 to be disposed such that the brake, for which the frequency of maintenance inspection work is comparatively high, is positioned on a lower side.

A second method for maintenance inspection work is a method in which the hoistway equipment is made removable relative to the supporting frame 12 from below the supporting frame 12, and maintenance inspection work is performed inside the hoistway 2 after the hoistway equipment is removed from the supporting frame 12. In this second method, maintenance inspection work can be performed in a comfortable position. The hoistway equipment may also be made displaceable downward to a position enabling maintenance inspection without being completely removed from the supporting frame 12.

In addition, a third method for maintenance inspection work is a method in which the cover 25 is removed, and maintenance inspection work on the hoistway equipment is performed from above the roof portion 3 through the opening portion 3a. The third method is also possible by disposing an openable and closable maintenance access hatchway on the cover 25. If maintenance inspection work on the driving machine 13 is to be performed from above, it is preferable for the driving machine 13 to be disposed such that the brake is positioned on an upper side.

### Embodiment 2

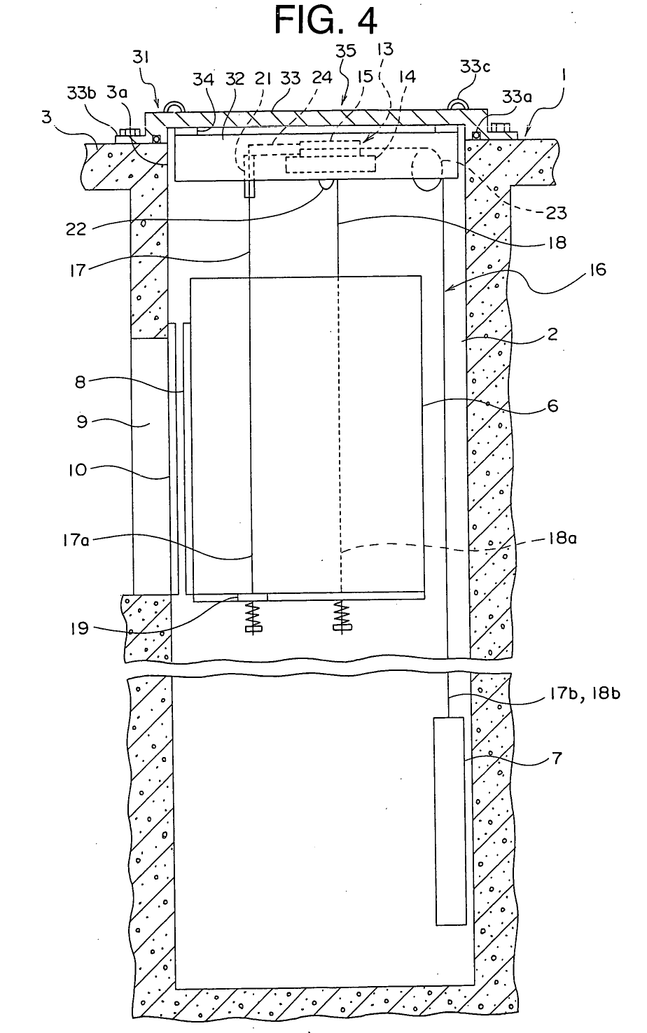

Next, FIG. 4 is a side elevation showing an elevator apparatus according to Embodiment 2 of the present invention. In the figure, a supporting frame 31 functioning as a cover body is disposed in an upper portion of a hoistway 2. The supporting frame 31 is supported by a roof portion 3.

The supporting frame 31 has: a supporting frame main body 32 for supporting a driving machine 13 and pulleys 21 through 24; a cover portion 33 for closing an opening portion 3a; and a linking portion 34 for linking the supporting frame main body 32 and the cover portion 33.

A seal portion 33a for preventing penetration of water into the opening portion 3a, a roof fixing portion 33b for fixing the supporting frame 31 to the roof portion 3, and suspending hooks (gripping portions) 33c to which a lifting apparatus (such as a crane apparatus, for example) for lifting the supporting frame 31 can be coupled are disposed on the cover portion 33. The cover portion 33 can also be constituted by a transparent material.

The driving machine 13 and the pulleys 21 through 24 are unitized by being mounted to the shared supporting frame 31. Specifically, a drive unit 35 according to Embodiment 2 includes the supporting frame 31, the driving machine 13, and the pulleys 21 through 24. Furthermore, in this example, the driving machine 13 and the pulleys 21 through 24 are generally disposed entirely inside the opening portion 3a. The rest of the configuration is similar to that of Embodiment 1.

Using an elevator apparatus of this kind, the supporting frame 31 can also be installed in a predetermined position in advance, enabling installation work time to be shortened. Furthermore, by using a supporting frame 31 including a cover portion 33, the opening portion 3a can be closed simultaneously simply by installing the supporting frame 31, enabling the efficiency of installation work to be further improved.

### Embodiment 3

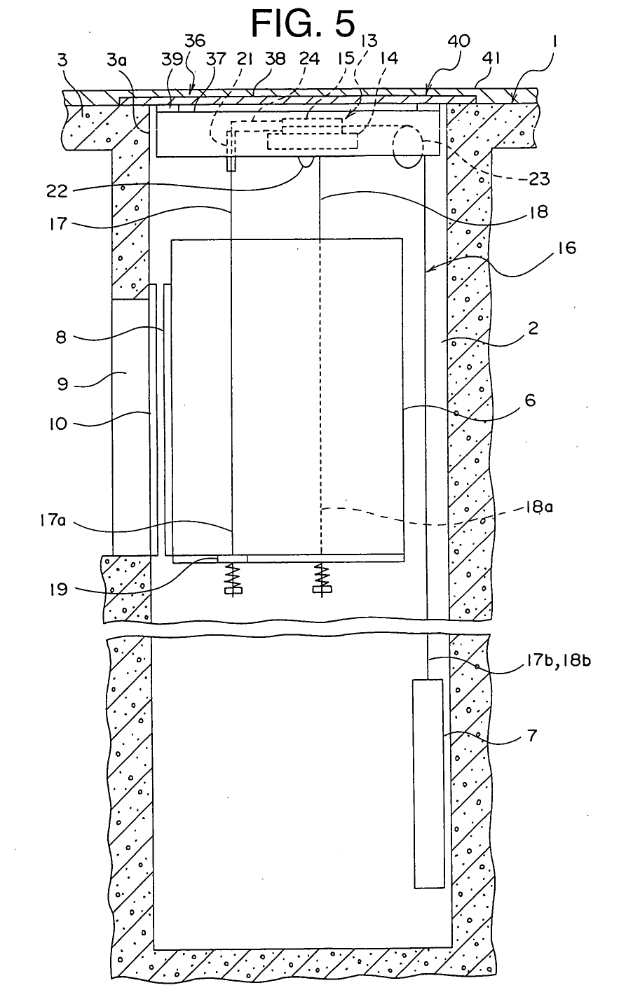

Next, FIG. 5 is a side elevation showing an elevator apparatus according to Embodiment 3 of the present invention. In the figure, a supporting frame 36 functioning as a cover body is disposed in an upper portion of a hoistway 2. The supporting frame 36 is supported by a roof portion 3.

The supporting frame 36 has: a supporting frame main body 37 for supporting a driving machine 13 and pulleys 21 through 24; a flat cover portion 33 for covering an opening portion 3a; and a linking portion 39 for linking the supporting frame main body 37 and the cover portion 38.

The driving machine 13 and the pulleys 21 through 24 are unitized by being mounted to the shared supporting frame 36. Specifically, a drive unit 40 according to Embodiment 3 includes the supporting frame 36, the driving machine 13, and the pulleys 21 through 24. Furthermore, in this example, the driving machine 13 and the pulleys 21 through 24 are generally disposed entirely inside the opening portion 3a.

An upper surface of the roof portion 3 is covered by a rooftop waterproofing layer 41. The rooftop waterproofing layer 41 is constituted by a resin, for example. The rooftop waterproofing layer 41 is also applied continuously over the cover portion 38.

The supporting frame 36 is disposed in a predetermined position during construction of the building before applying the rooftop waterproofing layer 41.

Using an elevator apparatus of this kind, the supporting frame 36 can also be installed in a predetermined position in advance, enabling installation work time to be shortened. Furthermore, since the rooftop waterproofing layer 41 is disposed over the supporting frame 36, it is not necessary to provide the supporting frame 36 with a waterproofing function, enabling the construction of the supporting frame 36 to be simplified.

Moreover, since the cover portion 38 does not need to have a waterproofing function, and needs only to cover the opening portion 3a, the cover portion 38 may also have a frame-shaped configuration or a configuration combining a frame and a net, for example. Thus, the supporting frame 36 can be made lightweight.

If waterproofing of the opening portion 3a is required before application of the rooftop waterproofing layer 41, a separate waterproofing sheet can also be placed over the supporting frame 36 temporarily.

In addition, the supporting frame 36 may also be provided with a waterproofing function to give the opening portion 3a a double waterproofing construction.

### Embodiment 4

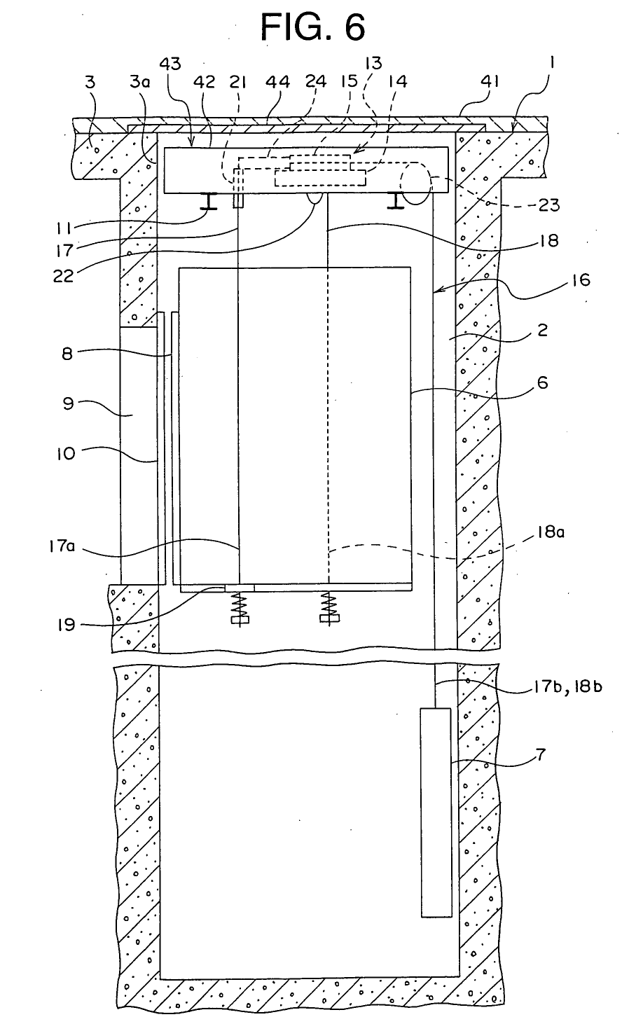

Next, FIG. 6 is a side elevation showing an elevator apparatus according to Embodiment 4 of the present invention. In Embodiment 4, a supporting frame 42 for supporting a driving machine 13 and pulleys 21 through 24 is supported by and fixed to structural beams 11. A drive unit 43 according to Embodiment 4 includes the supporting frame 42, the driving machine 13, and the pulleys 21 through 24.

A flat cover 44 covering an opening portion 3a is disposed on a roof portion 3. The cover 44 is configured as a separate part from the drive unit 43, and placed on the roof portion 3. An upper surface of the roof portion 3 is covered by a rooftop waterproofing layer 41. The rooftop waterproofing layer 41 is also applied continuously over the cover 44. The rest of the configuration is similar to that of Embodiment 3.

The supporting frame 42 is disposed on the structural beams 11 during construction of the building before applying the rooftop waterproofing layer 41. The cover 44 may be disposed simultaneously during installation of the supporting frame 42, or may also be disposed when the rooftop waterproofing layer 41 is applied.

Using an elevator apparatus of this kind, the supporting frame 42 can also be installed in a predetermined position in advance, enabling installation work time to be shortened. Because the supporting frame 42 is supported on the structural beams 11, loads from the car 6, the counterweight 7, and the drive unit 43 do not act on the cover 44, enabling the construction of the cover 44 to be simplified.

Moreover, since the cover 44 does not need to have a waterproofing function, and needs only to cover the opening portion 3a, the cover 44 may also have a frame-shaped configuration or a configuration combining a frame and a net, for example.

The cover 44 may also be eliminated and the opening portion 3a closed using only the rooftop waterproofing layer 41. In other words, the rooftop waterproofing layer 41 may also serve as a cover.

### Embodiment 5

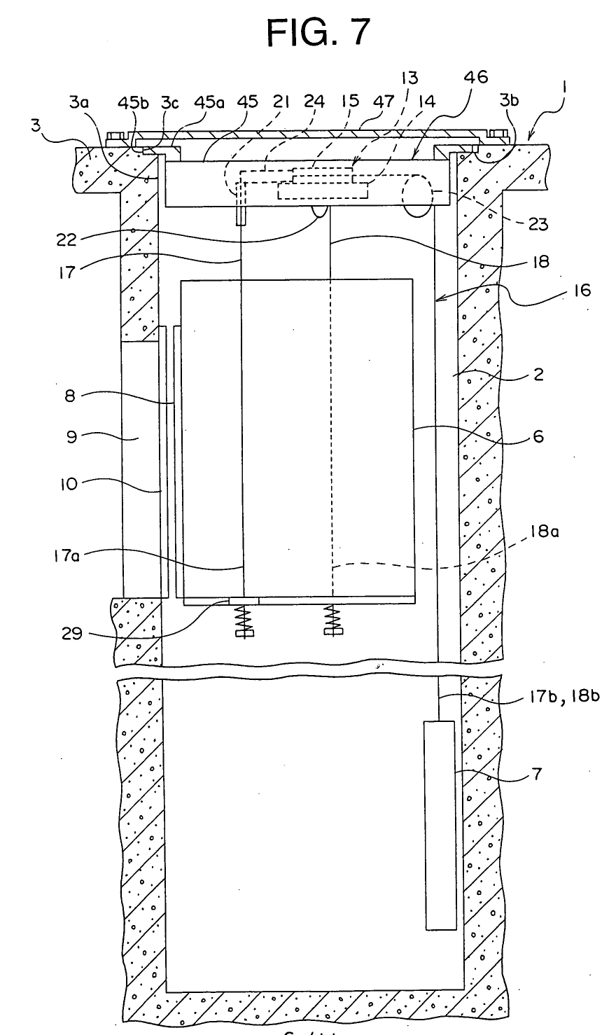

Next, FIG. 7 is a side elevation showing an elevator apparatus according to Embodiment 5 of the present invention. In the figure, a frame supporting portion (stepped portion) 3b is disposed on an edge portion of an opening portion 3a in a roof portion 3. A prepositioned reference surface 3c is disposed on the frame supporting portion 3b.

A supporting frame 45 for supporting a driving machine 13 and pulleys 21 through 24 is disposed in a top portion of a hoistway 2. A roof engaging portion (roof mounting portion) 45a engaging with the frame supporting portion 3b is disposed on the supporting frame 45. A positioning surface 45b placed in contact with the reference surfaces 3c is disposed on the roof engaging portion 45a.

Positioning of the supporting frame 45 in a depth direction of the hoistway 2 (left-to-right in FIG. 7) is performed by placing the positioning surface 45b in contact in the reference surface 3c. Although not shown, a reference surface and a positioning surface for performing positioning of the supporting frame 45 in a direction parallel to a width direction of a car 6 are disposed on the frame supporting portion 3b and the roof engaging portion 45a, respectively.

A drive unit 46 according to Embodiment 5 includes the supporting frame 45, the driving machine 13, and the pulleys 21 through 24. A cover 47 for closing the opening portion 3a is fixed onto the roof portion 3.

Using an elevator apparatus of this kind, the supporting frame 45 can also be installed in a predetermined position in advance, enabling installation work time to be shortened.

The supporting frame 45 can be positioned easily by placing the positioning surface 45b in contact with the reference surface 3c disposed on the building main body 1, enabling the efficiency of installation work to be improved.

### Embodiment 6

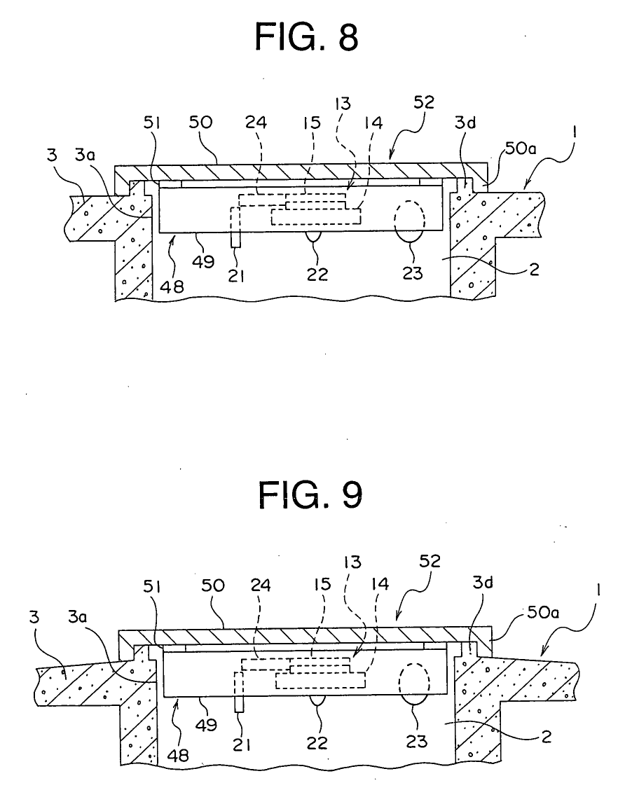

Next, FIG. 8 is a side elevation showing part of an elevator apparatus according to Embodiment 6 of the present invention. In the figure, a protruding portion 3d serving as both a waterproofing portion and a frame mounting portion is disposed on a roof portion 3. The protruding portion 3d is disposed so as to surround a perimeter of an opening portion 3a continuously.

A supporting frame 48 functioning as a cover body is disposed in an upper portion of a hoistway 2. The supporting frame 48 is supported by the roof portion 3.

The supporting frame 48 has: a supporting frame main body 49 for supporting a driving machine 13 and pulleys 21 through 24; a cover portion 50 for closing the opening portion 3a; and a linking portion 51 for linking the supporting frame main body 49 and the cover portion 50.

An interfitting portion 50a that joins together with or faces a side surface of the protruding portion 3d on an opposite side from the opening portion 3a is disposed on the cover portion 50. Positioning of the supporting frame 49 can also be performed using the side surface of the protruding portion 3d as a reference surface and an inner surface of the interfitting portion 50 as a positioning surface.

The driving machine 13 and the pulleys 21 through 24 are unitized by being mounted to the shared supporting frame 48. Specifically, a drive unit 52 according to Embodiment 6 includes the supporting frame 48, the driving machine 13, and the pulleys 21 through 24. Furthermore, in this example, the driving machine 13 and the pulleys 21 through 24 are generally disposed entirely inside the opening portion 3a.

Using an elevator apparatus of this kind, the supporting frame 48 can also be installed in a predetermined position in advance, enabling installation work time to be shortened. Furthermore, water can be prevented from penetrating into the opening portion 3a by a simple construction.

### Embodiment 7

Next, FIG. 9 is a side elevation showing part of an elevator apparatus according to Embodiment 7 of the present invention. In this example, an inclination is disposed on an upper surface of a roof portion 3. Specifically, the upper surface of the roof portion 3 inclines gently so as to become lower as it gets further away from a perimeter of an opening portion 3a. The rest of the configuration is similar to that of Embodiment 6.

By disposing an inclination on the upper surface of the roof portion 3 in this manner, water can be more reliably prevented from penetrating into the opening portion 3a.

### Embodiment 8

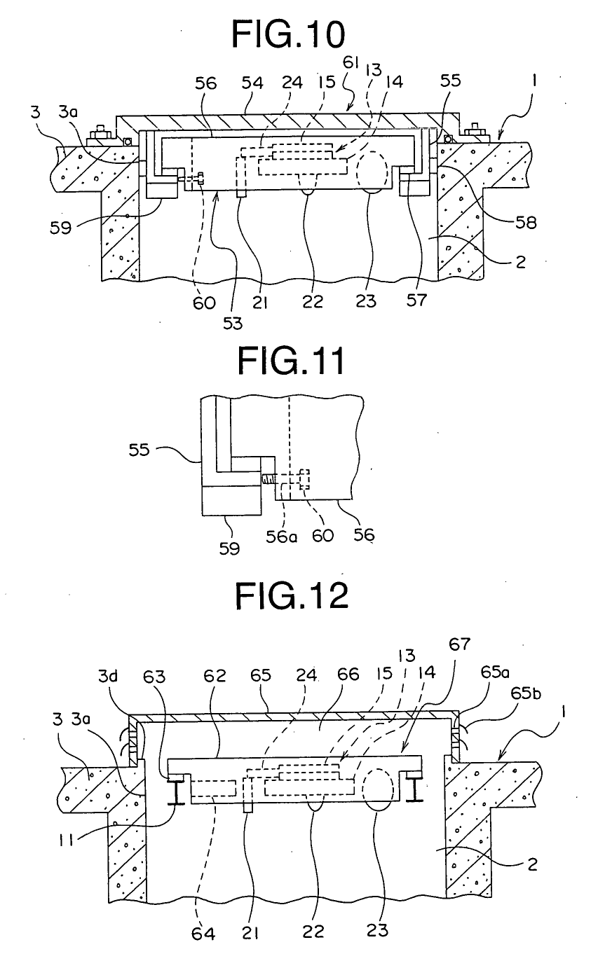

Next, FIG. 10 is a side elevation showing part of an elevator apparatus according to Embodiment 8 of the present invention, and FIG. 11 is an enlargement showing part of FIG. 10. In the figures, a supporting frame 53 functioning as a cover body is disposed in an upper portion of a hoistway 2. The supporting frame 53 is supported by a roof portion 3.

The supporting frame 53 has: a cover portion 54 fixed onto the roof portion 3; a plurality of supporting arms 55 fixed to a lower portion of the cover portion 54; and a supporting frame main body 56 supported by the supporting arms 55. A driving machine 13 and pulleys 21 through 24 are supported by the supporting frame main body 56.

A first buffering member 57 is interposed between the supporting arms 55 and the supporting frame main body 56. A second buffering member 58 is interposed between the supporting arms 55 and an inner surface of the opening portion 3a (hoistway wall). The first and second buffering members 57 and 58 are constituted by a rubber plate, for example.

A plurality of legs 59 are fixed to lower end portions of the supporting arms 55. If the supporting frame 53 with the driving machine 13 and the pulleys 21 through 24 mounted thereto is placed on a horizontal surface, the pulleys 21 through 23 are prevented from contacting the horizontal surface by the legs 59.

A screw-threaded aperture 56a is disposed in the supporting frame main body 56, and a position adjusting screw 60 is screwed into this screw-threaded aperture 56a. Consequently, the supporting frame main body 56 can be displaced relative to the building main body 1 in a depth direction of the hoistway 2 by adjusting the position of the position adjusting screw 60. Thus, the position of the driving machine 13 and the pulleys 21 through 24 relative to the building main body 1 can be adjusted. An equipment position adjusting mechanism according to Embodiment 8 includes the screw-threaded aperture 56a and the position adjusting screw 60.

A drive unit 61 according to Embodiment 8 includes the supporting frame 53, the driving machine 13, and the pulleys 21 through 24.

Using an elevator apparatus of this kind, the supporting frame 53 can also be installed in a predetermined position in advance, enabling installation work time to be shortened.

Because the first buffering member 57 is disposed between the supporting arms 55 and the supporting frame main body 56, propagation of vibrations from the driving machine 13 and the pulleys 21 through 24 to the building main body 1 can be suppressed. Because the second buffering member 58 is disposed between the supporting arms 55 and the hoistway wall, vibrations propagating to the building main body 1 can be reduced further.

In addition, because the legs 59 are disposed on the supporting frame 53, the drive unit 61 can be loaded onto a truck and transported, or placed at a factory or an installation site, etc., in an assembled state, enabling work efficiency to be improved. Damage to equipment contained in the drive unit 61 can also be prevented.

Because the position adjusting screw 60 is provided, the position of the driving machine 13 and the pulleys 21 through 24 relative to the building main body 1 can be adjusted easily.

Moreover, buffering members may also be disposed between the supporting frame 53 and the driving machine 13, the pulleys 21 through 24, etc.

In Embodiment 8, only position adjustment of the equipment in a depth direction of the hoistway 2 is shown, but position adjustment of the equipment in a direction parallel to a direction of frontage of a car may also be performed using a similar equipment position adjusting mechanism.

### Embodiment 9

Next, FIG. 12 is a side elevation showing part of an elevator apparatus according to Embodiment 9 of the present invention. A supporting frame 62 is supported on structural beams 11 with a buffering member 63 interposed. A control apparatus (control board) 64 functioning as hoistway equipment is mounted to the supporting frame 62 in addition to a driving machine 13 and pulleys 21 through 24. The driving machine 13 is controlled by the control apparatus 64. Specifically, raising and lowering of a car 6 and a counterweight 7 are controlled by the control apparatus 64. It is possible to inspect and maintain the control apparatus 64 from inside a hoistway 2.

A cover 65 for closing an opening portion 3a is disposed on a roof portion 3. A plurality of air vents 65a functioning as a cooling means are disposed on the cover 65. A plurality of hood portions 65b for preventing penetration of rain water into the air vents 65a are also disposed on the cover 65. A ventilation channel 66 is ensured between the cover 65 and the supporting frame 62.

A drive unit 67 according to Embodiment 9 includes the supporting frame 62, the driving machine 13, the pulleys 21 through 24, and the control apparatus 64.

Using an elevator apparatus of this kind, the supporting frame 62 can also be installed in a predetermined position in advance, enabling installation work time to be shortened.

Because the buffering member 63 is interposed between the supporting frame 62 and the structural beams 11, vibrations propagating from the driving machine 13 and the pulleys 21 through 24 to the building main body 1 can be reduced.

In addition, because the control apparatus 64 is mounted to the supporting frame 62, space inside the hoistway 2 can be used more effectively.

Because the ventilation channel 66 is ensured between the cover 65 and the supporting frame 62, heat from the control apparatus 64, the driving machine 13, etc., can be discharged outside the hoistway 2 efficiently.

### Embodiment 10

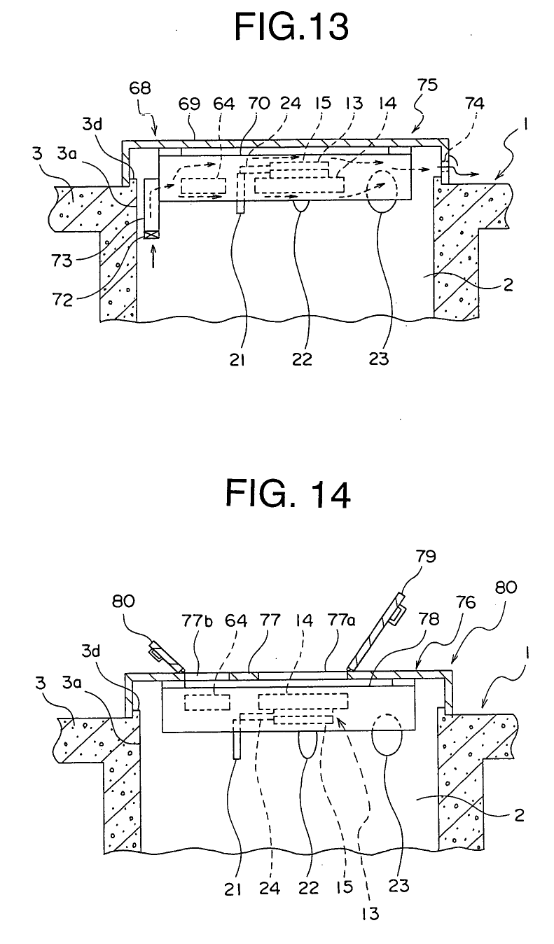

Next, FIG. 13 is a side elevation showing part of an elevator apparatus according to Embodiment 10 of the present invention. In the figure, a supporting frame 68 functioning as a cover body is disposed in an upper portion of a hoistway 2. The supporting frame 68 is supported by a roof portion 3.

The supporting frame 68 has: a cover portion 69 fixed onto the roof portion 3; and a supporting frame main body 70 fixed to a lower portion of the cover portion 69. A driving machine 13, pulleys 21 through 24, and a control apparatus 64 are supported by the supporting frame main body 70.

A ventilation channel is formed inside the supporting frame main body 70. The control apparatus 64 is disposed further upstream in the ventilation channel than the driving machine 13. A fan 72 functioning as a cooling means for introducing air from inside the hoistway 2 into the supporting frame main body 70 is connected to the supporting frame main body 70 by means of a duct 73.

An air outlet 74 is disposed on the cover portion 69 to discharge air that has passed through the supporting frame main body 70 outside the hoistway 2. A drive unit 75 according to Embodiment 10 includes the supporting frame 68, the driving machine 13, the pulleys 21 through 24, and the control apparatus 64.

Using an elevator apparatus of this kind, the supporting frame 68 can also be installed in a predetermined position in advance, enabling installation work time to be shortened.

Because the ventilation channel is disposed inside the supporting frame main body 70 and air is introduced into the ventilation channel by the fan 72, the control apparatus 64, the driving machine 13, etc., can be cooled efficiently.

In addition, because the air outlet 74 is disposed on the cover portion 69, heat from the control apparatus 64, the driving machine 13, etc., can be discharged outside the hoistway 2 efficiently.

Moreover, the fan 72 may also be disposed on the supporting frame main body 70 directly without using the duct 73.

A fan may also be disposed on a cover portion to introduce air from outside the hoistway into the supporting frame main body.

In addition, a fan may also be disposed on the air outlet.

The cooling means is not limited to fans, and various kinds of cooling means other than fans may also be disposed on a supporting frame.

### Embodiment 11

Next, FIG. 14 is a side elevation showing part of an elevator apparatus according to Embodiment 11 of the present invention. In the figure, a supporting frame 76 functioning as a cover body is disposed in an upper portion of a hoistway 2. The supporting frame 76 is supported by a roof portion 3.

The supporting frame 76 has: a cover portion 77 fixed onto the roof portion 3; and a supporting frame main body 78 fixed to a lower portion of the cover portion 77. A driving machine 13, pulleys 21 through 24, and a control apparatus 64 are supported by the supporting frame main body 78. A drive unit 80 according to Embodiment 11 includes the supporting frame 76, the driving machine 13, the pulleys 21 through 24, and the control apparatus 64.

A first maintenance access hatchway 77a for inspecting and maintaining the driving machine 13 and a second maintenance access hatchway 77b for inspecting and maintaining the control apparatus 64 are disposed on the cover portion 77. First and second maintenance access doors 79 and 80 for opening and closing the first and second maintenance access hatchways 77a and 77b are also disposed on the cover portion 77.

The driving machine 13 and the control apparatus 64 are disposed so as to enable maintenance inspections from above the hoistway 2 through the maintenance access hatchways 77a and 77b. The driving machine 13 in particular is disposed such that a driving machine main body 14 faces the first maintenance access hatchway 77a, in other words, such that a drive sheave 15 is below.

Using an elevator apparatus of this kind, the supporting frame 76 can also be installed in a predetermined position in advance, enabling installation work time to be shortened.

Because the maintenance access hatchways 77a and 77b are disposed on the cover portion 77, maintenance inspection work on the driving machine 13 and the control apparatus 64 can easily be performed from above the roof portion 3.

### Embodiment 12

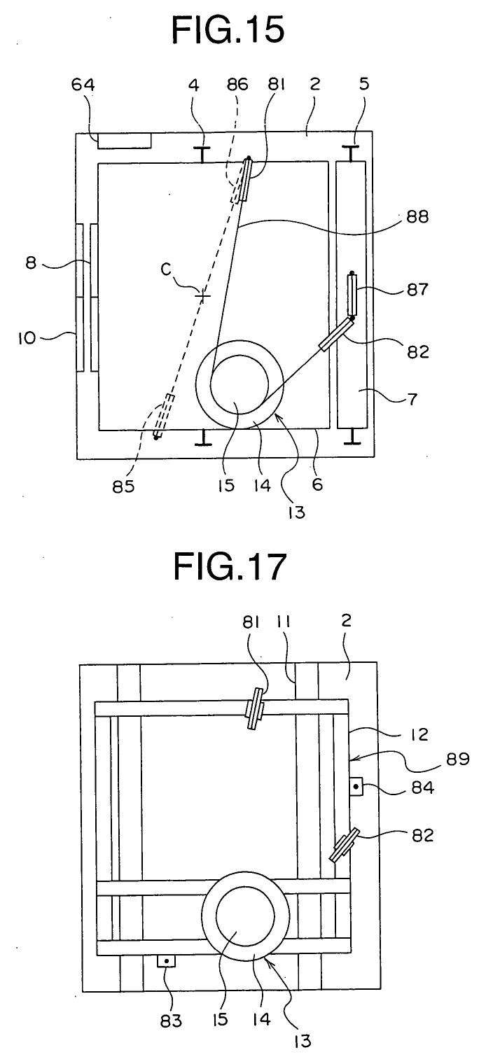

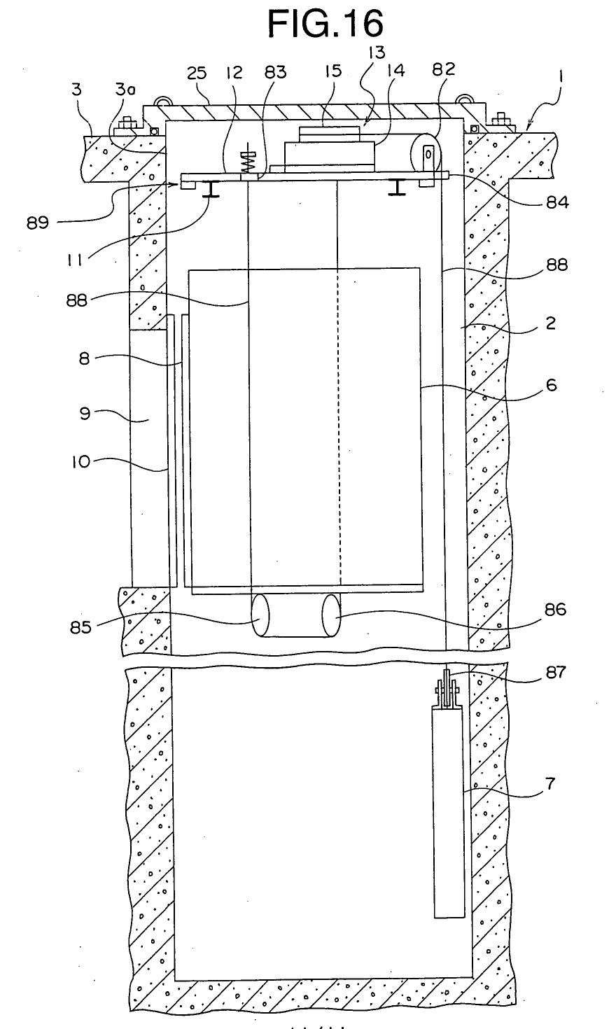

Next, FIG. 15 is a plan showing internal portions of a hoistway of an elevator apparatus according to Embodiment 12 of the present invention, FIG. 16 is a side elevation showing the elevator apparatus in FIG. 15, and FIG. 17 is a plan showing a state partway through installation of the elevator apparatus in FIG. 15.

The roping method of the elevator apparatus according to Embodiment 1 is configured into a two-to-one (2:1) roping method.

In the figures, a car return sheave 81 and a counterweight return sheave 82 are mounted to a supporting frame 12. A car rope fastener portion 83 and a counterweight rope fastener portion 84 are also disposed on the supporting frame 12. A drive unit 89 according to Embodiment 12 includes the supporting frame 12, the driving machine 13, and the return sheaves 81 and 82.

First and second car suspension sheaves 85 and 86 are disposed on a lower portion of a car 6. A counterweight suspension sheave 87 is disposed on an upper portion of a counterweight 7.

The car 6 and the counterweight 7 are suspended by a plurality of main ropes 88 (only one is shown in the figures). The main ropes 88 have: first end portions connected to the car rope fastener portion 83; and second end portions connected to the counterweight rope fastener portion 84.

The main ropes 88 are wound from the first end portions sequentially around the first car suspension sheave 85, the second car suspension sheave 86, the car return sheave 81, a drive sheave 15, the counterweight return sheave 82, and the counterweight suspension sheave 87.

The first and second car suspension sheaves 85 and 86 a redisposed such that the main ropes 88 extending between the first and second car suspension sheaves 85 and 86 pass through a center of gravity C of the car 6 when viewed from above. In other words, the car 6 is suspended substantially at its center of gravity. A control apparatus 64 is disposed between a hoistway wall and the car 6 when viewed from above.

Using an elevator apparatus of this kind, the supporting frame 12 can also be installed in a predetermined position in advance, enabling installation work time to be shortened. In other words, the present invention can be applied to elevator apparatuses using any roping method.

For example, the elevator apparatuses according to Embodiments 2 through 11 may also be configured using a two-to-one (2:1) roping method.

Moreover, the width dimension and the depth dimension of the opening portion may also be smaller than the width dimension and the depth dimension of the hoistway. In other words, the aperture surface area of the opening portion may also be smaller than the horizontal cross-sectional area of the hoistway depending on the size of the supporting frame.

In the above examples, thin hoisting machines are used, but cylindrical hoisting machines in which an axial dimension is longer than an outside diameter dimension of the entire apparatus may also be used. In that case, it is preferable for the hoisting machine to be arranged such that its shaft axis is horizontal.

In addition, in the above examples, driving machines, pulleys, and control apparatuses are shown as examples of hoistway equipment, but other hoistway equipment such as speed governors, for example, may also be mounted to a supporting frame.

In the above examples, elevator apparatuses in which a driving machine is disposed in an upper portion of a hoistway are shown, but the present invention can also be applied to elevator apparatuses in which a driving machine is disposed in a lower portion of a hoistway. In that case, return sheaves constituting hoistway equipment may be mounted to the supporting frame.

In the above examples, the supporting frame is supported by a roof portion or structural beams, but it may also be supported by guide rails. In that case, the supporting frame can be temporarily supported by the roof portion, structural beams, etc., before installation of the guide rails, and supported by the guide rails after installation of the guide rails.

In addition, the present invention can also be applied to elevator apparatuses in which an intermediate floor of the building is the highest floor stopped at. In that case, the highest service floor can be considered to be a building main body, an opening portion communicating with the hoistway can be disposed on a roof portion of the highest service floor, and the supporting frame can be carried in through the opening portion before construction of floors above the highest service floor is completed.

In the above examples, traction elevator apparatuses are shown, but the present invention can also be applied to other types of elevator apparatuses (such as drum elevators, linear motor elevators, etc., for example) provided that the elevator apparatus has hoistway equipment that is disposed in an upper portion of the hoistway.

The present invention can also be applied to multi-deck elevators, multi-car elevators, etc.

1. An elevator apparatus drive unit comprising:
a cover body disposed on an opening portion of a top portion of a hoistway; and
a driving machine having a drive sheave around which is wound a main rope for suspending a car and a counterweight, and a driving machine main body for rotating the drive sheave, the driving machine being supported by the cover body.

2. An elevator apparatus comprising:
a cover body disposed on an opening portion of a top portion of a hoistway;
a driving machine having a driving machine main body, and a drive sheave rotated by the driving machine main body, the driving machine being supported by the cover body;
a main rope wound around the drive sheave; and
a car and a counterweight suspended inside the hoistway by the main rope and raised and lowered by a driving force from the driving machine.

3. An elevator apparatus comprising:
a hoisted body raised and lowered inside a hoistway that includes an opening portion disposed on a roof portion of a building main body;
a supporting frame disposed in an upper portion of the hoistway; and
hoistway equipment disposed on the supporting frame.

4. The elevator apparatus according to claim 3, wherein the hoistway equipment includes a driving machine for raising and lowering the hoisted body.

5. The elevator apparatus according to claim 3, wherein the hoistway equipment includes a rotatable pulley around which is wound a main rope for suspending the hoisted body inside the hoistway.

6. The elevator apparatus according to claim 3, wherein the hoistway equipment includes a control apparatus for controlling raising and lowering of the hoisted body.

7. The elevator apparatus according to claim 3, further comprising a cover disposed on the roof portion so as to cover the opening portion.

8. The elevator apparatus according to claim 3, wherein a cover portion for covering the opening portion is included on the supporting frame.

9. The elevator apparatus according to claim 3, wherein a roof fixing portion for fixing the supporting frame to the roof portion is disposed on the supporting frame.

10. The elevator apparatus according to claim 3, wherein a beam fixing portion for fixing the supporting frame to a structural beam fixed to an upper portion of the building main body is disposed on the supporting frame.

11. The elevator apparatus according to claim 3, wherein the supporting frame has a supporting frame main body, and an equipment position adjusting mechanism for adjusting a mounted position of the hoistway equipment relative to the supporting frame main body.

12. The elevator apparatus according to claim 3, wherein a positioning surface that can be placed in contact with a reference surface disposed on the building main body is disposed on the supporting frame.

13. The elevator apparatus according to claim 3, further comprising a frame position adjusting mechanism for adjusting a mounted position of the supporting frame relative to the building main body.

14. The elevator apparatus according to claim 3, further comprising a guide rail installed inside the hoistway, the guide rail guiding raising and lowering of the hoisted body,
a rail positioning portion for performing relative positioning between the hoistway equipment and the guide rail being disposed on the supporting frame.

15. The elevator apparatus according to claim 3, wherein the hoistway equipment is removable relative to the supporting frame from below the supporting frame.

16. The elevator apparatus according to claim 3, wherein a suspending hook to which a lifting apparatus for lifting the supporting frame can be coupled is disposed on the supporting frame.

17. The elevator apparatus according to claim 3, wherein a leg is disposed on the supporting frame so as to prevent the hoistway equipment from contacting a horizontal surface when the supporting frame mounted with the hoistway equipment is placed on the horizontal surface.

18. The elevator apparatus according to claim 3, wherein at least a portion of the supporting frame and the hoistway equipment is disposed inside the opening portion.

19. An elevator apparatus installation method for an elevator apparatus comprising a hoisted body raised and lowered inside a hoistway disposed in or on a building main body, a supporting frame disposed in an upper portion of the hoistway, and hoistway equipment disposed on the supporting frame,
the elevator apparatus installation method including:
a carrying-in and installing process in which the supporting frame is carried inside the hoistway through an opening portion disposed at a top portion of the hoistway from above the opening portion and installed in an upper portion inside the hoistway; and
an equipment mounting process in which the hoistway equipment is mounted to the supporting frame.

20. The elevator apparatus installation method according to claim 19, wherein the equipment mounting process is executed before the carrying-in and installing process.

21. The elevator apparatus installation method according to claim 19, wherein the equipment mounting process is executed after the carrying-in and installing process.

22. The elevator apparatus installation method according to claim 19, further including a process in which a guide rail for guiding raising and lowering of the hoisted body is installed inside the hoistway based on a position of the hoistway equipment.

23. The elevator apparatus installation method according to claim 19, further including:
a process in which a guide rail for guiding raising and lowering of the hoisted body is installed inside the hoistway; and
a process in which a position of the hoistway equipment is adjusted based on a position of the guide rail.

24. An elevator apparatus maintenance inspection method for an elevator apparatus comprising a hoisted body raised and lowered inside a hoistway that includes an opening portion disposed on a roof portion of a building main body, a supporting frame disposed in an upper portion of the hoistway, and hoistway equipment disposed on the supporting frame,
the elevator apparatus maintenance inspection method including:
a process in which maintenance inspection work on the hoistway equipment is performed inside the hoistway from below the supporting frame.

25. An elevator apparatus maintenance inspection method for an elevator apparatus comprising a hoisted body raised and lowered inside a hoistway that includes an opening portion disposed on a roof portion of a building main body, a supporting frame disposed in an upper portion of the hoistway, and hoistway equipment disposed on the supporting frame,
the elevator apparatus maintenance inspection method including:
a process in which the hoistway equipment is removed from the supporting frame inside the hoistway; and
a process in which maintenance inspection work is performed on the hoistway equipment.

26. An elevator apparatus maintenance inspection method for an elevator apparatus comprising a hoisted body raised and lowered inside a hoistway that includes an opening portion disposed on a roof portion of a building main body, a supporting frame disposed in an upper portion of the hoistway, and hoistway equipment disposed on the supporting frame,
the elevator apparatus maintenance inspection method including:
a process in which maintenance inspection work on the hoistway equipment is performed from above the roof portion through the opening portion.
